(19) United States
(12) Patent Application Publication
(10) Pub. No.: US 2007/0244792 A1
(43) Pub. Date: Oct. 18, 2007

(54) Execution monitoring system for financial instruments

(75) Inventors: Frederic Couperier, Portchester, NY (US); Christopher Dacre-Wright, Larchmont, NY (US); Jose Lopez, New York, NY (US)

Correspondence Address: DAVIDSON, DAVIDSON & KAPPEL, LLC, 485 SEVENTH AVENUE, 14TH FLOOR, NEW YORK, NY, 10018, US

(73) Assignee: GL Trade Americas Inc., New York, NY (US)

(21) Appl. No.: 11/403,725

(22) Filed: Apr. 13, 2006

(51) Int. Cl. G06Q 40/00

(52) U.S. Cl. 705/37

(57) ABSTRACT

A computerized method of monitoring compliance comprises: (a) receiving information regarding an order for a financial instrument which was executed at a first one of a plurality of automated trading centers against a protected quotation of said first trading center, the information including at least an order time at which the order was placed, an identifier sufficient to identify said financial instrument, a volume of the order, an identifier sufficient to identify said first trading center; and a price of the order; (b) receiving market data for said financial instrument, said market data including each protected quotation for the financial instrument at each of the plurality of automated trading centers during a grace period extending from a second time, which is prior to said order time, to said order time; (c) comparing said protected quotation of said first trading center at the order time to each other protected quotation for the financial instrument at the order time, and: (1) if none of the other protected quotations is a better quotation than said protected quotation, identifying the order as compliant; (2) if any of the other protected quotations is a better quotation than said protected quotation, searching the market data for the financial instrument during said grace period, and: (i) if at any time during the grace period none of the other protected quotations had a better quotation than said protected quotation, identifying the order as compliant, and, if not, identifying the order as an order for which compliance has not been demonstrated.

### FIELD OF THE INVENTION

The present invention relates to the field of electronic order routing and execution of financial instruments on exchanges, ECNs, and other trading centers.

### BACKGROUND

On Apr. 6, 2005, the Securities and Exchange Commission of the United States adopted Regulation NMS. Regulation NMS was subsequently published in Securities Exchange Act Release No. 51808 (Jun. 9, 2005), 70 FR 37496 (Jun. 29, 2005). See also Division of Market Regulation: Responses to Frequently Asked Questions Concerning Rule 611 and Rule 610 of Regulation NMS (Jan. 27, 2006) (available at http://www.sec.gov/divisions/marketreg/rule611faq.pdf).

Regulation NMS (“RegNMS”) includes, inter alia, (1) Rule 610, which addresses access to markets; (2) Rule 611, also referred to as the “order protection rule”, which provides inter-market price priority for displayed and accessible quotations; (3) Rule 612, which establishes minimum pricing increments; and (4) amendments to the joint-industry plans and rules governing the dissemination of market data.

Rule 611 requires automated trading centers (e.g., ECNs, electronic exchanges, and other execution destinations that qualify as “automated” under Rule 600(b)(4)) to promulgate and enforce written policies and procedures reasonably designed to prevent “trade-throughs”. A “trade-through” is the execution of a trade at a price inferior to “protected” quotations displayed by other automated trading centers. To be a protected quotation, a quotation must be immediately and automatically accessible. As such, under Rule 611, if an automated trading center receives an order, it cannot fill that order at a price that is less than a protected quotation displayed by other automated trading centers, and must either match the price of the protected quote or reroute the order to the automated trading center displaying the superior protected quotation. Rule 611(b), however, includes a number of exceptions to this requirement. For example, if an automated trading center receives an inter-market sweep order (“ISO”), the trading center must execute the order immediately without regard to better-priced protected quotations at other trading centers.

Rule 611 allows order-routers to directly control the handling of their orders to comply with Rule 611, rather than relying on the trading centers themselves to execute and route orders in compliance with Regulation NMS. In this regard, an order router is a company which routes orders to trading centers. Examples of order routers include Lava Trading, Royal Blue, and GL Trade, among others.

One way that an order-router can control the handling of an order to comply with Rule 611 is by designating the order an inter-market sweep order (the ISO exception, discussed above). The use of an ISO designation enables the destination trading center to execute the order immediately without regard to better-priced protected quotations at other trading centers. However, the broker-dealer routing the order must assume the responsibility for transmitting additional orders, as necessary, to execute against any better-priced protected quotations. In other words, the order router is responsible for Regulation RMS compliance of ISO orders. By designating an order an ISO order and routing it to an automated trading center, an order router indicates an intention to execute against an automated trading center's protected quotation (assuming that the price of the protected quotation on arrival of the order is within the ISO's limit price). The destination trading center is required to execute the ISO at a price at least as favorable as the price of the protected quotation (unless previously executed or withdrawn). Further, the execution at the price of the protected quotation is subject to SEC fee limitations (see Rule 610(c)), regardless of whether the order was executed against displayed protected quotation or a reserve size.

### SUMMARY OF THE INVENTION

In accordance with a first embodiment of the present invention, a computerized method of monitoring compliance is provided. The method includes the step of receiving information regarding an order for a financial instrument which was executed at a first one of a plurality of automated trading centers against a protected quotation of said first trading center. The information includes at least an order time at which the order was placed, an identifier sufficient to identify said financial instrument, a volume of the order, an identifier sufficient to identify said first trading center; and a price of the order. The method further comprises receiving market data for said financial instrument, wherein said market data includes each protected quotation for the financial instrument at each of the plurality of automated trading centers during a grace period which extends from a second time, which is prior to said order time, to said order time. Preferably, the second time is 1 second prior to the order time (i.e., a 1 second grace period). Alternately, the grace period can be set to another value or can be variable.

In accordance with the method, said protected quotation of said first trading center at the order time is compared to each other protected quotation for the financial instrument at the order time, and if none of the other protected quotations is a “better quotation” than said protected quotation, identifying the order as compliant. In the context of the present invention, the term “better quotation” means, in the context of bid quotation, a higher priced bid, and in the case of an “ask” quotation, a lower priced ask.

If any of the other protected quotations is a better quotation than said protected quotation, the method searches the market data for the financial instrument during said grace period, and: if at any time during the grace period none of the other protected quotations had a better quotation than said protected quotation, the method identifies the order as compliant, and, if not, the method identifies the order as an order for which compliance has not been demonstrated.

In accordance with a further aspect of the first embodiment prior to said step of “receiving information”, the method comprises the step of receiving information regarding an inter-market sweep order, wherein the inter-market sweep order is comprised of a plurality of orders executed against automated quotations from different ones of the automated trading centers. In this regard, the “order” in the “receiving information” step discussed above, corresponds to one of the plurality of orders which make up the inter-market sweep order, and the method steps described above are performed for each of the plurality of orders in the inter-market sweep order.

In accordance with a further aspect of the first embodiment of the present invention, market data playback is provided by performing the steps of receiving a financial instrument identifier, and rendering market data for the financial instrument as an order book over time on a display screen.

In accordance with a second embodiment of the present invention, a method of monitoring performance of a plurality of trading centers comprises (a) receiving information regarding orders for financial instruments which were executed at trading centers, including, for each order an order time at which the order was placed, and an execution time at which the order was executed; and (b) determining a response time metric for each of the plurality of trading centers, the response time metric for each trading center being calculated as a function of the order times and the execution times of the orders placed at said each trading center.

In accordance with a third embodiment of the present invention, a method of monitoring performance of a plurality of trading centers comprises: (a) receiving information regarding orders for financial instruments which were executed at trading centers, including, for each order an order price of the order and an executed price of the order; and (b) determining, for each of the plurality of trading centers, a price accuracy metric, the price accuracy metric for each trading center being a function of the order prices and the execution prices of the orders placed at said each trading center.

In accordance with a fourth embodiment of the present invention, a method of monitoring performance of a plurality of trading centers, comprising: (a) receiving information regarding orders for financial instruments which were executed at trading centers, including, for each order an order volume of the order and an executed volume of the order; and (b) determining, for each of the plurality of trading centers, a volume accuracy metric, the volume accuracy metric for each trading center being a function of said order volumes and said execution volumes of the orders placed at said each trading center.

Preferably, however, the second, third and fourth embodiments are provided together, and the method of monitoring performance includes a response time metric, a price accuracy metric and a volume accuracy metric.

In accordance with a fifth embodiment of the present invention, a compliance monitor is provided which includes an execution monitoring server and a monitoring client.

The execution monitoring server receives information regarding an order for a financial instrument which was executed at a first one of a plurality of automated trading centers against a protected quotation of said first trading center. The information includes at least an order time at which the order was placed, an identifier sufficient to identify said financial instrument, a volume of the order, an identifier sufficient to identify said first trading center; and a price of the order. The server also receives market data for said financial instrument, said market data including each protected quotation for the financial instrument at each of the plurality of automated trading centers during a grace period extending from a second time, which is prior to said order time, to said order time. The server compares said protected quotation of said first trading center at the order time to each other protected quotation for the financial instrument at the order time, and if none of the other protected quotations is a better quotation than said protected quotation, identifies the order as compliant. If any of the other protected quotations is a better quotation than said protected quotation, the server searches the market data for the financial instrument during said grace period, and if at any time during the grace period none of the other protected quotations had a better quotation than said protected quotation, identifies the order as compliant, and, if not, identifies the order as an order for which compliance has not been demonstrated.

The execution monitor client is operable to display said protected quotation of said first trading center at the order time and each other protected quotation for the financial instrument at the order time on a display screen. Preferably, the client also displays each protected quotation for the financial instrument at said any time on a display screen.

### BRIEF DESCRIPTION OF THE DRAWINGS

FIG. 1 shows an illustrative execution monitoring system in accordance with an embodiment of the present invention, an order routing system, and a plurality of exchanges, ECNs and Brokers.

FIG. 2 shows the execution monitoring system of FIG. 1 in further detail.

FIG. 3 shows an illustrative order entry screen for a graphical user interface (GUI) for the order routing system of FIG. 1.

FIG. 4 shows an illustrative compliance check screen for a GUI of the compliance monitor of the execution monitoring system of FIG. 2.

FIG. 5 shows an illustrative destinations monitor screen for a GUI of the destinations monitor of the execution monitoring system of FIG. 2.

FIG. 6 shows an illustrative intra-day playback screen for a GUI of the intraday playback function of the execution monitoring system of FIG. 2.

### DETAILED DESCRIPTION

In accordance with an embodiment of the present invention, an execution monitoring system is provided. The execution monitoring system includes one or more of a RegNMS compliance monitor, a destination monitor, and an intra-day playback function. The execution monitoring system can be implemented as a stand-alone software package or can be combined with an order entry and/or order routing system.

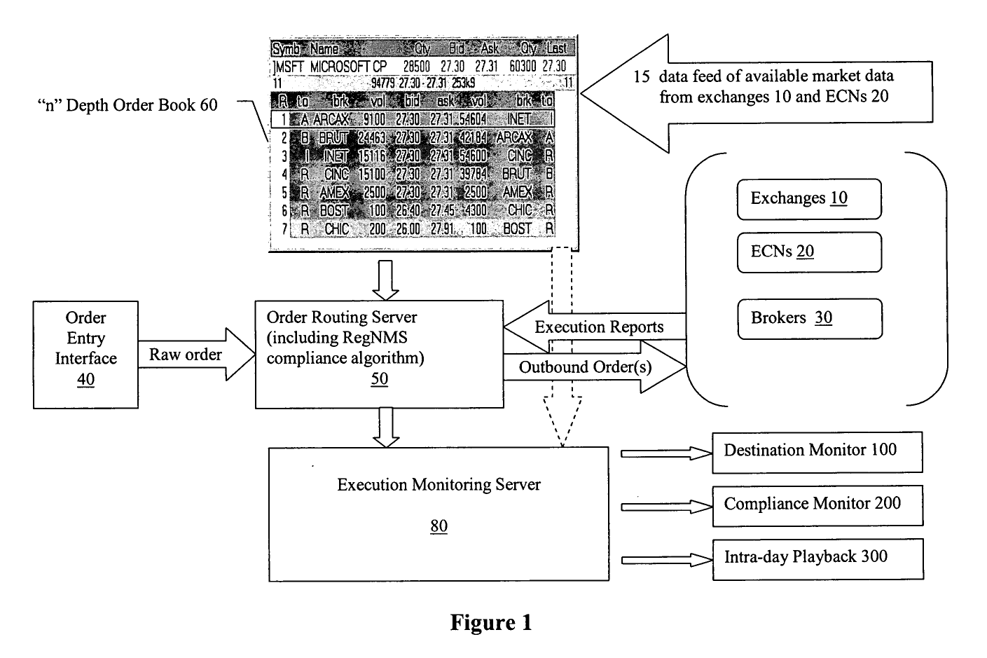

FIG. 1 shows an illustrative execution monitoring system including execution monitoring server 80, destination monitor 100, RegNMS compliance monitor 200, and intra-day playback 300. Components 100, 200, and 300 may be implemented as software “clients” located remote from the server. Also illustrated in FIG. 1 is an order entry and routing system including an order entry interface 40 and an order routing server 50. In this illustration, the execution monitoring system and order entry and routing system each receive data from n-depth order book 60. As such, n-depth order book 60 is, for purposes of FIG. 1, part of both the execution monitoring system and the order entry and routing system. Order book 60 may be implemented as a separate software process or can be integrated into the routing server and/or monitoring server. FIG. 1 further includes three types of trading centers: exchanges 10, ECNs 20, and brokers 30.

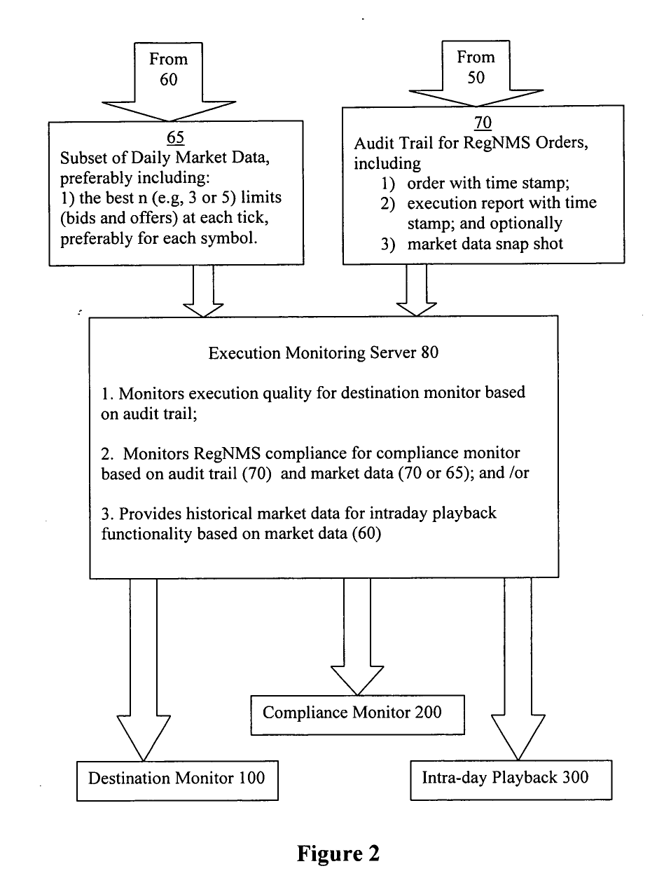

The arrows in FIG. 1 (and FIG. 2, discussed below) are provided to illustrate the general flow of information between components. As one of ordinary skill in the art will appreciate, the components in FIGS. 1-6 can be implemented as software executing on one or more computers interconnected via known networking techniques. As such, a detailed discussion of the manner in which orders can, for example, be entered by a user at a trading terminal through order interface 40, transmitted to an order routing server 50, and then routed to exchanges 10, ECNs 20, and brokers 30 is unnecessary and is not provided herein.

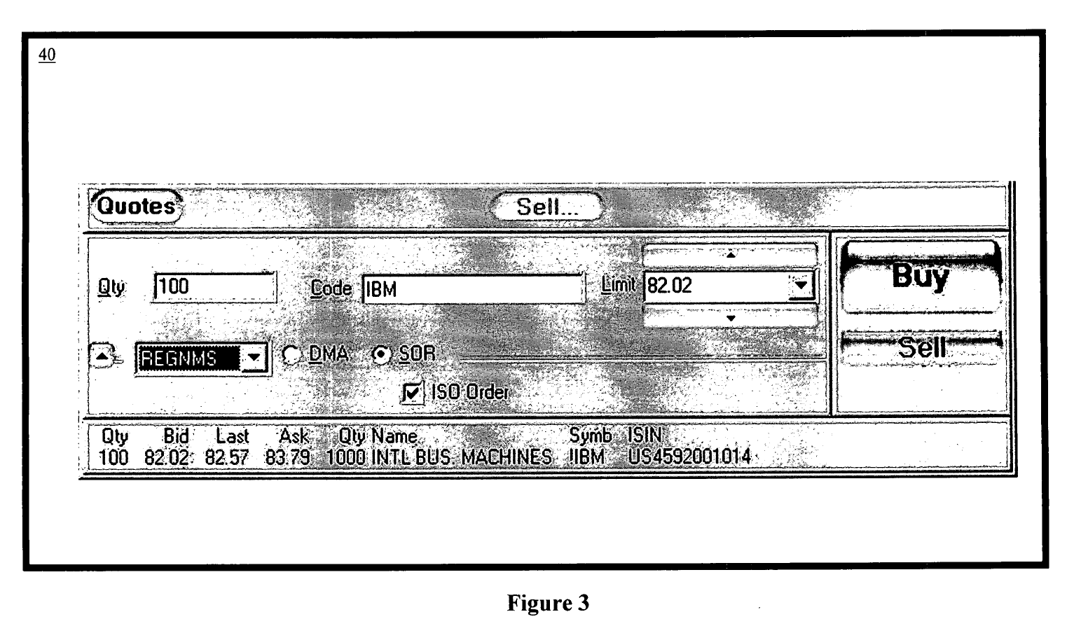

Prior to discussing the operation of the execution monitoring system, it is appropriate to discuss the operation of the system being monitored—the order entry and routing system. Referring to FIG. 3, an illustrative pop-up order entry screen is shown. It should be appreciated that the order entry screen of FIG. 3 is merely illustrative, and that alternative order entry interfaces can be used, as known in the art, which may include additional or fewer features, provided that it is capable of providing sufficient information to initiate an order.

The pop-up screen includes a drop down menu which is selected to RegNMS. This indicates that Regulation NMS compliance will be handled by the Order Routing Server 50. The screen also includes selections/fields for SRO (Smart Order Routing), DMA (Direct Market Access), ISO (Inter-market Sweep Order), code (e.g. financial instrument identifier such as security symbol), limit price, and volume. In this illustration, the trader has indicated that he wishes to place a RegNMS, ISO order for 100 shares of IBM with a limit price of 82.02. The trader can then select (i.e., with a mouse click) to send it as either a buy or sell order by selecting either the “buy” or “sell” button. For convenience, at the bottom of the pop-up screen, the current best bid (price 82.2, quantity 100 shares), best ask (price 83.79, quantity 1000 shares), and last traded price 82.57 is shown. By designating the order RegNMS, ISO, the trader indicates that the automated trading centers will not be handling RegNMS compliance. As such, the broker executing the trade is charged with ensuring RegNMS compliance. The broker can fulfill this duty through its own internal software and procedures or through the use of a third party order routing service which is RegNMS compliant.

After an order is placed, it is transmitted to order routing server 50 as a “raw order”. Order routing server may be located at a broker (e.g. Citibank), or may be remotely located to service a plurality of brokers. Further, the order routing server 50 may be implemented on the same or different computers from the order entry interface 40. As order routing servers 50 are well known, the discussion herein will focus on the additional functionality that is implemented in accordance with the embodiments of the present invention to comply with Regulation NMS' order protection rule as applied to ISO orders.

Smart order routing (SOR) is a generic term which encompasses a wide variety of algorithms used to take a raw order from a trader (e.g., buy 1000 shares of IBM with a limit price of 72.03), and route it as one or more outbound orders to one or more trading centers for execution. An ISO order is a specific type of SOR order.

When a raw order is received with an ISO designation, the order routing server 50 analyzes the available market data (the displayed bids and asks from the exchanges, ECNs and other trading centers to which the order routing server has access). The order routing server 50 receives the available market data from data feed 15. Although data feed 15 is shown as a single arrow, it should be understood that each trading center (exchange, ECN, or broker) generally sends its own data feed to the order routing server 50. Generally, each data feed includes all of the displayed bids (price and volume) and asks (price and volume) for each symbol available from the trading center. This is commonly referred to as the “full book” or “full order book”. As such, assuming the order routing server 50 had access to an ARCA data feed, a NASD data feed, and INET data feed, the data feed 15 would include ARCA's “full order book”, INET's full order book, and NASD Level II data. However, as explained below, for a variety of reasons, the order routing server 50 may only analyze a portion of the available data. This is indicated in FIG. 1 as n-depth order book 60, where n can vary from 1 to infinity, where infinity corresponds to “full” book.

Order routing server 50, upon receiving an ISO order, searches the available market data for the best prices that meet the limit price of the order, determines which trading centers offer the best price(s), and sends outbound orders to one or more of the automating trading centers based on this determination. Thus, for example, if the “raw” ISO order seeks to sell 2000 shares at a limit price of 27.00, and the available market data shows a bid at 27.30 for 1000 shares from ARCA and a bid of 27.20 for 100 shares at INET, and a bid of 27.10 of 1000 shares from ARCA, the order routing server 50 would typically send an outbound order for 1000 shares to ARCA to hit the 27.30 bid, and an outbound order for 1000 shares to INET to hit the 27.20 bid.

The Regulation NMS Order Protection Rule (Rule 611) introduces the concept of a “protected quotation” to ISO order processing. A “protected quote” is a displayed quotation (i.e., bid or ask): (i) from an automated trading center; (ii) which is an automated quotation (as opposed to manual quotation or non-firm quotation). An automated quotation “must be immediately and automatically accessible up to its full size, which will include both the displayed and reserve size of the quotation” Securities Exchange Act Release No. 51808 (Jun. 9, 2005), 70 FR 37496 (Jun. 29, 2005), at 37534 n. 313. In this regard, trading centers include information in the datafeed 15 sufficient to distinguish automated quotations from non-automated quotations such as manual quotations and non-firm quotations.

The order routing server 50, upon receiving a RegNMS ISO order, is required to execute against better displayed protected quotations that satisfy the limit price of the ISO, prior to executing against any inferior quotations, even if the protected quotation cannot fill the entire quantity of the ISO order. The order routing server 50, may, however, in executing an RegNMS ISO order, send an outbound order against a single protected quotation in excess of its displayed size, hoping to execute against a reserve quantity, provided that it does not include in its sweep any orders at prices inferior to another protected quotation. In other words, before executing against an inferior price, an Reg NMS ISO order must execute against all better protected quotations up to their full displayed quantities.

In accordance with a first embodiment of the present invention, a Reg NMS compliance monitoring system is provided which demonstrates compliance (or lack of compliance) of executed trades with the Reg NMS order protection rule. With RegNMS' Order Protection Rule, after a trade has been executed, the entity responsible for compliance must be able to prove that its fill(s) (the outbound orders sent to trading centers based on a Reg NMS ISO order) complied with the rule. If one (or more) fill(s) didn't comply, the entity must either i) prove that it chose a valid exemption or ii) prove that the fill(s) fell within the 1 second ‘grace period’ granted by the SEC. The one second grace period exception provides that a fill sent against a protected quotation at an inferior price will still be deemed in compliance with RegNMS if the price of the protected quotation was the best protected quotation at some point during the previous one second before the fill was sent. In other words, if the non-compliant fill would have been in compliance with the order protection rule at any point during the second prior to time the fill was sent, then the order is in compliance with the order protection rule even though it was routed to a protected quotation at an inferior price.

In accordance with the first embodiment of the present invention, a RegNMs compliance monitoring system is provided which evaluates compliance of executed trades with the Reg NMS order protection rule, and, in cases where an order was routed against a protected quotation at an inferior price, determines whether order is nevertheless Reg NMS compliant under the one second grace period.

Referring to FIGS. 1, 2, and 4, the compliance monitoring system includes execution monitoring server 80 and compliance monitor 200. The execution monitoring server receives and stores, via audit trail 70, a time-stamped copy of the information relating to the order, and via daily market data 65, the best “n” bids/asks for each symbol, for each trading center, updated in real-time.

Referring to FIG. 2, the execution monitoring server compares the time-stamped information regarding the orders to the corresponding market data at the time of the order to determine if the order was routed to a trading center showing the best protected quote. The market data at the time of the order can be obtained from the stored best “n” bids/asks data because the stored data comprises a historical record of the market data for that day (or other desired set time period e.g., 4 hours, 8 hours, 16 hours, 24 hours, 2 days, 30 days). Alternatively, in embodiments where the execution monitoring server 80, the order routing server 50 and n-depth order book 60 form part of a single integrated system, the audit trail 70 can include, with the time stamped order information, a time-stamped market data snap-shot generated from the n-depth order book 60 at the time the order was placed.

If the comparison of the time-stamped information regarding the orders to the corresponding market data at the time of the order reveals that the order was routed to a trading center showing the best protected quote, then the order has complied with the Order Protection Rule and no further processing is required.

However, if the comparison reveals that a better protected quote was displayed at the time of the order, the execution monitoring server will search backward through one second of historical data for the trading center that received the order to determine whether, at any point during the 1 second grace period, the trading center's quote was the best displayed price. If it was, then compliance with the order protection rule has demonstrated. If it was not, then the order protection rule may have been violated unless the broker can demonstrate another exception such that the trading center was not fulfilling its duties (e.g., immediate execution, non-flickering quotes, etc.).

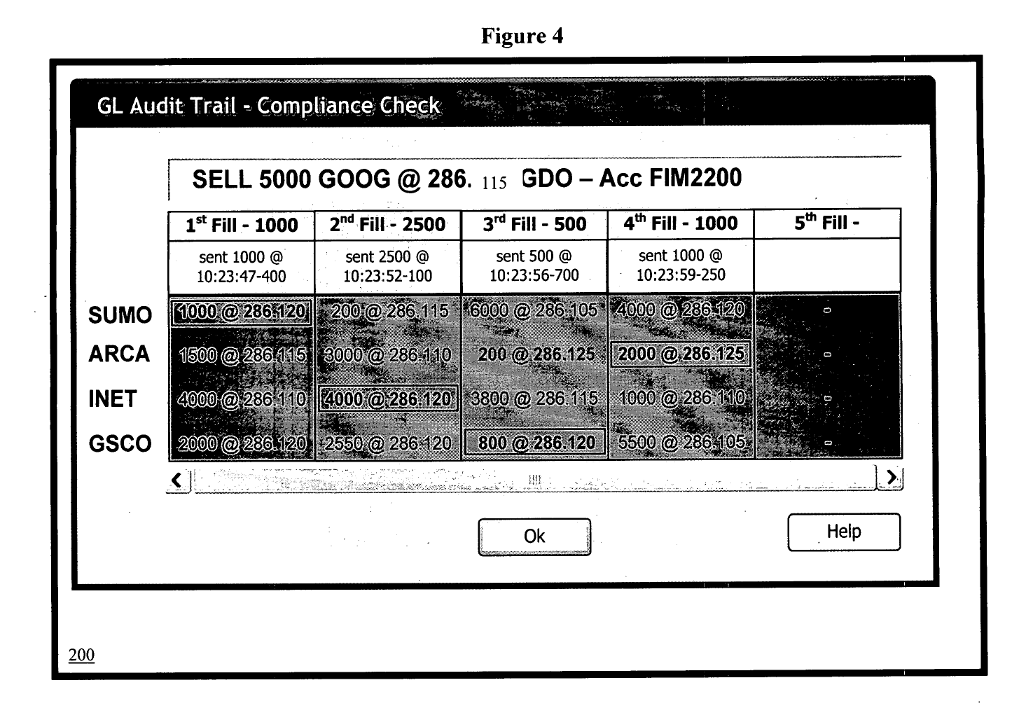

FIG. 4 shows a compliance monitor display screen which can be used to graphically demonstrate compliance with the order protection rule. In the example of FIG. 4, a compliance check has been performed by the execution monitor server 80 for RegNMS ISO order to sell 5000 shares of Google (GOOG) $286.115. As illustrated, the ISO order was routed by a routing server into four separate outbound orders (or “fills”): 1) 1000 shares to SUMO @ $286.120; 2) 2500 shares to INET @286.120; 3) 500 shares to GSCO @286.120; and 4) 1000 shares to ARCA at $286.125.

Turning to FIG. 4: the first fill (1000 shares to SUMO @ $286.120) is compliant because $286.120 is equal to or better than the other available quotations ($286.115, $286.110, and $286.120); the second fill (2500 shares to INET @ $286.120) is compliant because $286.120 is equal to or better than the other available quotations ($286.115, $286.110, and $286.120); and the fourth fill (1000 shares to INET @ $286.125) is compliant because $286.125 is equal to or better than the other available quotations ($286.105, $286.110, and $286.120). However, the third fill of 500 shares was sent to an inferior quotation (@286.120 at GSCO), because at the time of the order (10:23:56-700), 200 shares were available from ARCA at a better price ($286.125). In accordance with the order protection rule, the order routing server was required to send at least 200 shares to ARCA at $286.125, before sending an order to GSCO at $286.120. Therefore, the display in FIG. 4 represents the superior bid ($286.125) in red, to indicate that the third fill may not be compliant.

The execution monitoring server then searches backward from 10:23:56:700 to 10:23:55:70 to determine whether at any time during that 1 second interval, GSCO @ $286.120 was the best price. If it was, then the third fill was compliant. If it was not, then compliance for the third fill has not been established. In the illustrated display screen of FIG. 4, the results of the 1 second grace period analysis are not displayed. Rather, in that illustration, upon selecting OK or by selecting the price in red, or upon some other user action, an additional screen is displayed which indicates whether the third fill is compliant by virtue of the 1 second grace period, and provides the time at which GSCO @ $286.120 was the best price. Alternatively, the information regarding the 1 second grace period analysis could be provided in the screen of FIG. 4. In certain embodiments, FIG. 4 may display non-protected quotes as well as protected quotes.

At this point, it is appropriate to discuss the n-depth order book is further detail. As explained above, the datafeed 15 generally includes real time (i.e., current) information on all of the displayed quotations from each trading center (e.g., the quotations that the trading centers disseminate to their members). As such, if the n-depth order book maintains all of this information, the n-depth order book would generally be referred to as a “full order book”, and in the nomenclature of this discussion would correspond to n=infinity. However, in the context of the execution monitoring system according to the present invention, it is not necessary to maintain or process “full depth” order book information. Rather, it is expected that processing and maintaining real time information regarding the 3, 4, or 5 best price quotes (e.g. a 3-depth, 4-depth, or 5-depth order book) for each symbol for each liquidity pool (e.g., each exchange 10 or ECN 20 or broker 30) will provide sufficient information to demonstrate RegNMS compliance. Furthermore, by limiting the data processed and stored by the execution monitoring server conserves computational resources, thereby improving system performance.

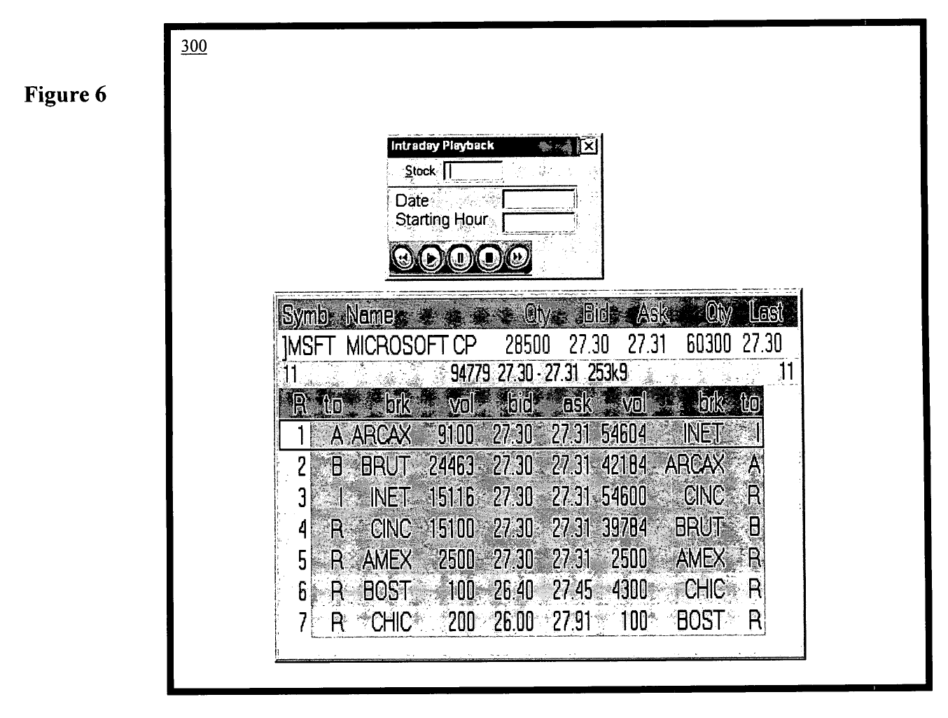

FIG. 6 shows an illustrative intra-day playback screen 300 for a GUI of the intraday playback feature in accordance with a third embodiment of the present invention. Referring to FIG. 6, a user enters a symbol (e.g. IBM), a date, and a starting time, and then selects the play button. As explained above, the execution monitoring server receives and stores, via daily market data 65, the best “n” bids/asks for each symbol, for each trading center, updated in real-time. Upon selection of the play button, the execution monitoring server retrieves the stored real-time data for the entered symbol, and renders it as an order book as illustrated in FIG. 6 over time. As illustrated in FIG. 6, an order book, when displayed to a trader, is displayed for a given security (symbol, in this case Microsoft), with the bids (price, broker, volume) displayed in descending price order with the highest price on top, and the asks (price, broker and volume) displayed in ascending price order with the lowest price on top. Above the order book is displayed the “top of book”: the best bid (27.30), the best ask (27.31), and the last traded price (27.30) from the NBBO (National Best Bid and offer) feed. Also included on the intraday playback screen is a forward fast button, which when selected causes the execution monitoring server to retrieve the stored real-time data for the entered symbol, and renders it as an order book faster than during the “play” option; a pause button, to pause the display, a stop button to stop the display, and a rewind button which causes the execution monitoring server to retrieve the stored real-time data for the entered symbol, and render it as an order book over time in reverse.

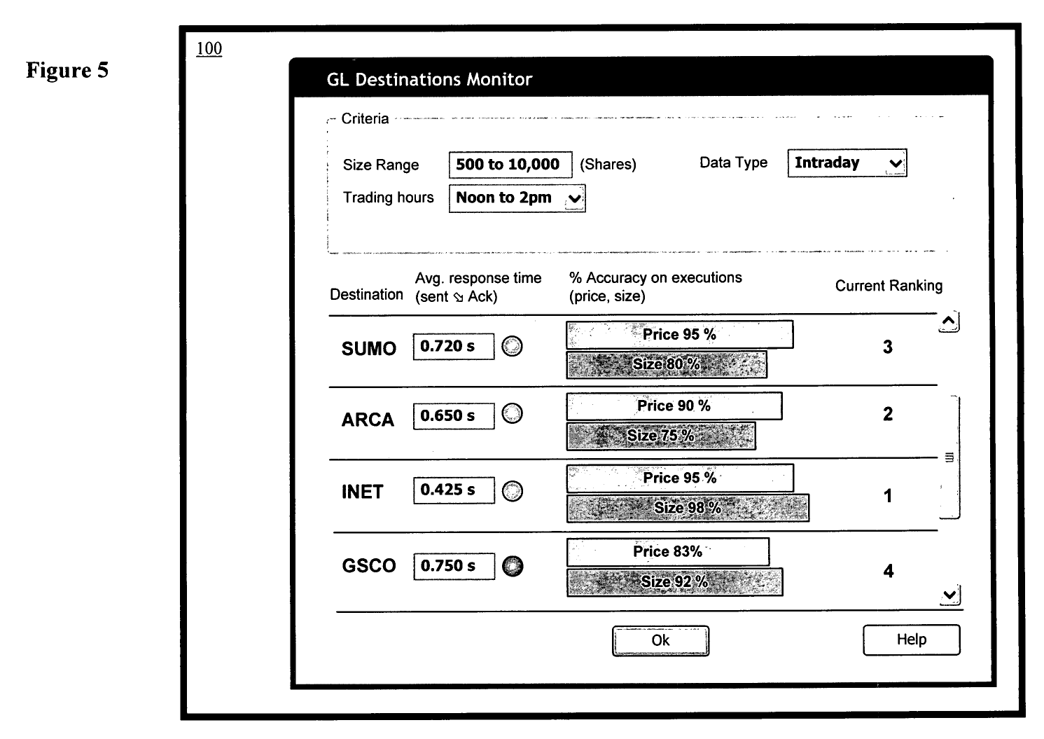

FIG. 5 shows an illustrative destination monitor in accordance with another embodiment of the present invention. The destination monitor monitors, for each trading center: i) the average response time (acknowledgement time minus sent time); ii) the percent accuracy on price (percentage of the time your order was executed at the price displayed at the time of the order); and iii) the percent accuracy on size (percentage of the time that your entire order (up to the display size) was executed). Further, these values can be filtered according size range, trading hours, and data type (intraday vs. after hours). The information in the destination monitor display 100 is generated by the execution monitor server based on the stored audit trail information 70.

For example, to determine the average response time and accuracy of ARCA, the server 80 can retrieve the audit trail for each trade which falls within the filter definitions (e.g., each trade on ARCA between 10 AM and 12 PM with a volume between 500 and 2000). For each audit trail, it could then determine:

A) a response time (e.g., “time of order” timestamp minus “time of execution report” time stamp);

B) whether the order was filled at the requested price (e.g., from the data in the execution report) Yes or No; and

C) whether the entire order was filled up to the display volume (e.g., “No” if the (lesser of display quantity and order quantity) minus fill quantity >0, otherwise Yes). Based on this information: i) the average response time of ARCA could then be calculated as an average of the response times (A) for each audit trail; the percentage accuracy on price would be number of Yes responses in (B) divided by the number of audit trails; and the percentage accuracy on volume would be number of Yes responses in (C) divided by the number of audit trails.

Preferably, the above information: order time; time of execution (e.g., either the execution time or acknowledgement time); order price; order volume, execution price; execution volume (e.g., fill quantity); are derived from the execution reports sent to the order router from the trading centers and forwarded to the server 80.

Additional metrics can also be generated based on other mathematical functions such as the median or weighted averages. For example, a destination ranking can be generated by a straight or weighted average of the average response time, percent price accuracy, and percent size accuracy. Further, other indicia, such as colored lights, which indicate whether a destination is satisfying a predetermined metric. For example, a red light could be associated with a destination which has a response time of more than X seconds (e.g. 0.740 seconds) and/or a price accuracy of less than Y % (e.g. 85%) and/or a size accuracy of less than Z (e.g. 75%).

The execution monitor can generate the response time and percent accuracy on price and size: i) in real time (i.e., based on continuously updated information from the data feed 15), for example, by continuously analyzing the audit trail data for the last 100 executions on each destination or for all executions on each destination for the current day, iii) based on historical data, such as all of the audit trail data from the previous day, week or month; or iv) based on a combination of real time and historical data.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A computerized method of monitoring compliance, comprising:
(a) receiving information regarding an order for a financial instrument which was executed at a first one of a plurality of automated trading centers against a protected quotation of said first trading center, the information including at least an order time at which the order was placed, an identifier sufficient to identify said financial instrument, a volume of the order, an identifier sufficient to identify said first trading center; and a price of the order;
(b) receiving market data for said financial instrument, said market data including each protected quotation for the financial instrument at each of the plurality of automated trading centers during a grace period extending from a second time, which is prior to said order time, to said order time;
(c) comparing said protected quotation of said first trading center at the order time to each other protected quotation for the financial instrument at the order time, and:
(1) if none of the other protected quotations is a better quotation than said protected quotation, identifying the order as compliant;
(2) if any of the other protected quotations is a better quotation than said protected quotation, searching the market data for the financial instrument during said grace period, and:
(i) if at any time during the grace period none of the other protected quotations had a better quotation than said protected quotation, identifying the order as compliant, and, if not, identifying the order as an order for which compliance has not been demonstrated.

2. The method of claim 1, wherein the second time is 1 second prior to the order time.

3. The method of claim 1, wherein, prior to step (a), the method comprises receiving information regarding an inter-market sweep order, wherein the inter-market sweep order is comprised of a plurality of orders executed against automated quotations from different ones of the automated trading centers, and wherein the steps (a) through (c) are performed for each of the plurality of orders.

4. The method of claim 1, wherein step (c) further comprises displaying said protected quotation of said first trading center at the order time and each other protected quotation for the financial instrument at the order time on a display screen.

5. The method of claim 1, wherein step (c)(2)(i) further comprises displaying each protected quotation for the financial instrument at said any time on a display screen.

6. The method of claim 1, further comprising the step of providing market data playback, the step of providing market data playback comprising:
receiving a financial instrument identifier; and
rendering market data for the financial instrument as an order book over time on a display screen.

7. The method of claim 1, wherein step (b) comprises continuously receiving market data for each of the plurality of financial instruments during a monitoring period.

8. The method of claim 7, wherein the monitoring period is 16 hours.

9. The method of claim 7, wherein the monitoring period is 24 hours.

10. The method of claim 7, further comprising the step of providing market data playback, the step of providing market data playback comprising:
receiving a financial instrument identifier and a start time, the start time being within the monitoring period; and
rendering market data for the financial instrument as an order book over time on a display screen beginning at the start time.

11. The method of claim 1, wherein:
step (a) comprises receiving information regarding a plurality of orders for a plurality of financial instruments which were executed at a plurality of automated trading centers, and wherein the information for each order further includes information regarding an execution time at which the order was executed, and wherein
the method further comprising the step of providing a destination monitor, the step of providing the destination monitor including the steps of:
determining a response time metric for each of the plurality of trading centers, the response time metric for each trading center being calculated as a function of the order times and the execution times of the orders placed at said each trading center.

12. The method of claim 11, wherein the function is an average.

13. The method of claim 11, wherein the function is a median.

14. The method of claim 11, wherein the information for each order further includes an execution price, and wherein the method further comprises determining, for each of the plurality of trading centers, a price accuracy metric, the price accuracy metric for each trading center being a function of the order prices and the execution prices of the orders placed at said each trading center.

15. The method of claim 11, wherein the information for each order further includes an execution volume, and wherein the method further comprises determining, for each of the plurality of trading centers, a volume accuracy metric, the volume accuracy metric for each trading center being a function of said order volumes and said execution volumes of the orders placed at said each trading center.

16. A method of monitoring performance of a plurality of trading centers, comprising:
(a) receiving information regarding orders for financial instruments which were executed at trading centers, including, for each order:
(i) an order time at which the order was placed, and an execution time at which the order was executed;
(ii) a order volume of the order and an executed volume of the order; and
(iii) an order price of the order and an executed price of the order;
(b) determining a response time metric for each of the plurality of trading centers, the response time metric for each trading center being calculated as a function of the order times and the execution times of the orders placed at said each trading center;
(c) determining, for each of the plurality of trading centers, a price accuracy metric, the price accuracy metric for each trading center being a function of the order prices and the execution prices of the orders placed at said each trading center; and
(d) determining, for each of the plurality of trading centers, a volume accuracy metric, the volume accuracy metric for each trading center being a function of said order volumes and said execution volumes of the orders placed at said each trading center.

17. A method of monitoring performance of a plurality of trading centers, comprising:
(a) receiving information regarding orders for financial instruments which were executed at trading centers, including, for each order an order time at which the order was placed, and an execution time at which the order was executed;
(b) determining a response time metric for each of the plurality of trading centers, the response time metric for each trading center being calculated as a function of the order times and the execution times of the orders placed at said each trading center;

18. The method of claim 17, wherein the time of execution for each order is either an acknowledgement time or an execution time of the order as determined from an execution report from the trading center executing the order.

19. A method of monitoring performance of a plurality of trading centers, comprising:
(a) receiving information regarding orders for financial instruments which were executed at trading centers, including, for each order, an order price of the order and an executed price of the order; and
(b) determining, for each of the plurality of trading centers, a price accuracy metric, the price accuracy metric for each trading center being a function of the order prices and the execution prices of the orders placed at said each trading center.

20. A method of monitoring performance of a plurality of trading centers, comprising:
(a) receiving information regarding orders for financial instruments which were executed at trading centers, including, for each order an order volume of the order and an executed volume of the order; and
(b) determining, for each of the plurality of trading centers, a volume accuracy metric, the volume accuracy metric for each trading center being a function of said order volumes and said execution volumes of the orders placed at said each trading center.

21. A compliance monitor comprising:
an execution monitoring server, the server executable on a computer and including executable process steps operable to control the computer to:
(a) receive information regarding an order for a financial instrument which was executed at a first one of a plurality of automated trading centers against a protected quotation of said first trading center, the information including at least an order time at which the order was placed, an identifier sufficient to identify said financial instrument, a volume of the order, an identifier sufficient to identify said first trading center; and a price of the order;
(b) receive market data for said financial instrument, said market data including each protected quotation for the financial instrument at each of the plurality of automated trading centers during a grace period extending from a second time, which is prior to said order time, to said order time;
(c) compare said protected quotation of said first trading center at the order time to each other protected quotation for the financial instrument at the order time, and:
(1) if none of the other protected quotations is a better quotation than said protected quotation, identifying the order as compliant,
(2) if any of the other protected quotations is a better quotation than said protected quotation, searching the market data for the financial instrument during said grace period, and:
(i) if at any time during the grace period none of the other (protected quotations had a better quotation than said protected quotation, identifying the order as compliant, and, if not, identifying the order as an order for which compliance has not been demonstrated; and
an execution monitor client, the client executable on a computer and including executable process steps operable to control the computer to display said protected quotation of said first trading center at the order time and each other protected quotation for the financial instrument at the order time on a display screen.

22. The monitor of claim 21, wherein the client displays each protected quotation for the financial instrument at said any time on a display screen.

23. The monitor of claim 22, wherein the client also displays unprotected quotations at said order time and said any time.
